(19) United States
(12) Patent Application Publication
(10) Pub. No.: US 2010/0018132 A1
(43) Pub. Date: Jan. 28, 2010

(54) Eternal Light Monument

(76) Inventor: Randy Manning, Rocky Mount, NC (US)

Correspondence Address: MEGAN LYMAN, 1816 SILVER MIST CT., RALEIGH, NC, 27613, US

(21) Appl. No.: 12/178,723

(22) Filed: Jul. 24, 2008

(51) Int. Cl. E04H 13/00; E04D 13/18; G09F 19/00

(52) U.S. Cl. 52/104; 52/173.3; 40/124.5

(57) ABSTRACT

The present invention is an eternal light monument that may use solar energy lighting in conjunction with a frame-mounted storyboard inscribed with graphics and information relating to a decedent. The storyboard may be constructed of a variety of translucent materials that are resistant to the elements and when receives light, achieve a “glowing” effect. The present invention is a cost-effective, customizable, and replaceable option for memorial construction.

### BACKGROUND

1. Field of Invention

This invention relates to monuments in general, and in particular, to novel monuments used as headstones, grave markers, mausoleum plaques, or memorials that may illuminate.

2. Brief Description of the Prior Art

Traditional headstones, grave markers, mausoleum plaques and memorials are generally constructed of granite, marble, or comparable stone materials and may contain metal plaques affixed thereto. These traditional monuments are costly, and generally permanent in nature. Once in place, if a family wishes to refresh the monument, a new one is constructed at great expense. The materials used to construct traditional monuments are generally opaque and do not have the ability to “glow,” or illuminate from within. Additionally, traditional monuments are generally either straight vertically or horizontally oriented in relation to the earth.

Methods of providing illumination to traditional monuments are well known. For example, U.S. Pat. No. 6,761,465 describes a mounting assembly that attaches to a monument and allows for the attachment of a solar-powered light. The anticipated use of such a device is to make the inscriptions on an opaque traditional monument visible where sunlight is in low supply.

Transparent materials that allow for the embedding of personal and decorative items within the monument have been described in U.S. Pat. No. 4,304,076. These monuments, the same shape as a traditional headstone, being solid in nature and oriented vertically from the earth, may be illuminated by placing a lamp on top of the monument, so that light penetrates through the vertical monument.

Moreover, small memorials that may ornament a monument or the like have also been described. (See U.S. Pat. No. 7,125,138). The use of translucent materials that are inscribed with graphics and information regarding a decedent that may be illuminated such that the headstone has a “glow” that radiates upward, have not been described.

Presently, no monument exists that is substantially translucent, oriented at an angle from the earth for ease of viewing, capable of receiving light therethrough, economical, and replaceable. There is a need for monuments that provide “eternal light” and give off a “glow” when visible light is not present in a manner that is readable, cost-effective, and customizable. The present invention addresses these needs. As will be seen from the subsequent description, the preferred embodiment of the present invention overcomes these and other shortcomings of the prior art.

### SUMMARY OF THE INVENTION

The present invention is an eternal light monument that may use solar energy lighting in conjunction with a frame-mounted storyboard inscribed with graphics and information relating to a decedent. The storyboard may be constructed of a variety of translucent materials that are resistant to the elements including glass, polymers, fiberglass, epoxies, resins, polycarbonates, molding compounds, glues, plastics, and the like.

One object of the present invention is to provide a translucent monument that may be illuminated, which is customizable, easily replaceable, and comparatively inexpensive.

Consequently, the storyboard of the present invention is coupled to a frame. The frame may either be affixed to the storyboard's lower surface through the use of screws or the like, or the frame may have an upper and lower portion where the storyboard may fit between the upper and lower portion. The upper portion of the frame may be constructed into two pieces, one piece being operable to connect to the lower portion by a ridge and sliding mechanism over the top of the storyboard. A cover that is also clear in nature may be connected to the upper portion of the frame such that the storyboard is not directly exposed to the elements. The frame, in one embodiment is connected to four legs that extend into the earth, anchoring the storyboard into the earth.

To achieve the object mentioned above, the present invention may be illuminated from below the storyboard through use of solar-lighting, so that illumination is constant or is activated when visible light is in low supply. The lighting apparatus may be equipped with devices that sense sunlight, and when the amount of sunlight dips below a prescribed threshold, the light is activated, providing illumination through the storyboard. The lighting apparatus may be affixed to the elongated members or the frame to accomplish illumination of the storyboard. The lighting apparatus may be attached to other parts of the present invention to accomplish the same effect.

Moreover, the present invention is very affordable in comparison to traditional monuments because of the materials used. The storyboard may be replaced over time. Inscriptions into or onto the storyboard are customizable and relatively simple to accomplish. Size and shape of the monument is also customizable, as is the color of light used to illuminate the storyboard.

Still other aspects of the present invention will become apparent to those skilled in the art from the following description of a preferred embodiment, which is by way of illustration, one of the best modes contemplated for carrying out the invention. As will be realized, the invention is capable of other different and obvious aspects, all without departing from the invention. Accordingly, the drawings and descriptions are illustrative in nature and not restrictive.

### DESCRIPTION OF THE DRAWINGS

The foregoing aspects and many of the accompanying advantages of this invention will become more readily appreciated as the same becomes understood by reference to the following detailed description, when taken in conjunction with the accompanying drawings, wherein:

FIG. 1 is a rendering of the eternal light monument in front view, according to one preferred embodiment of the present invention.

FIG. 2 is a rendering of the eternal light monument in a side view, according to one embodiment of the present invention.

FIG. 3 is a rendering of the eternal light monument in a cross-sectional view, according to one embodiment of the present invention.

FIG. 4 is an illustration of a top view of the storyboard and upper frame of the eternal light monument, according to one embodiment of the present invention.

FIG. 5 is a rendering of a side section view illustrating how the storyboard and frame couple with one another, according to one embodiment of the present invention.

### DETAILED DESCRIPTION

The detailed explanation of the present invention is described below. The described preferred embodiments are presented for the purpose of illustration and description; they are not intended to limit the scope of the present invention. As will be apparent to one skilled in the art, modifications to described elements below may be made without deviating from the scope of the present invention.

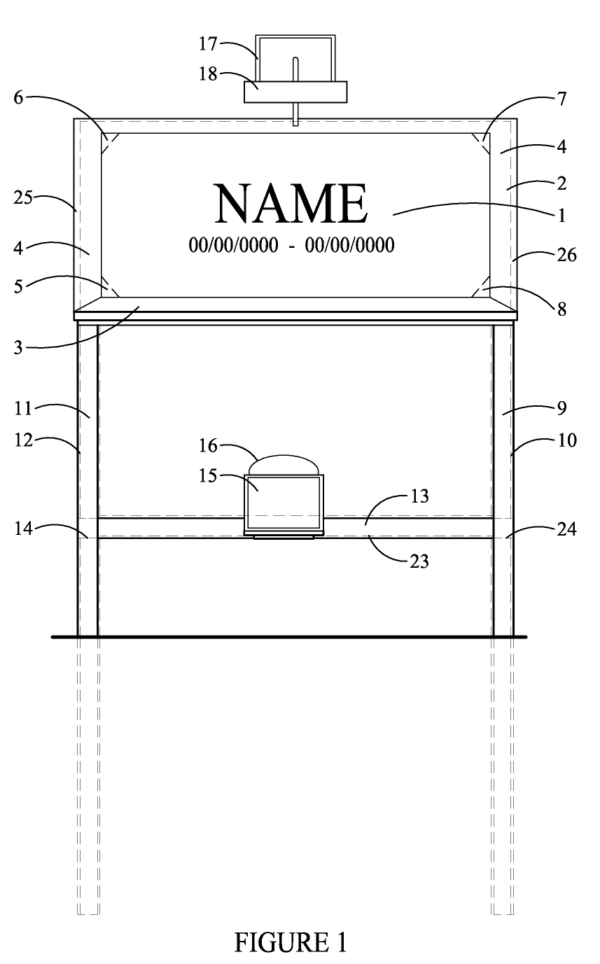

FIG. 1 shows a frontal view of the present invention. The storyboard 1 can be made of a variety of translucent materials including glass, polymers, fiberglass, epoxies, resins, polycarbonates, molding compounds, glues, and plastics. In one preferred embodiment the storyboard 1 is made of LEXAN® plastic, a polycarbonate resin sheet material and molding compound, registered by General Electric Company. The storyboard 1 may be inscribed with information regarding the decedent when the present invention is a headstone, as in one preferred embodiment. The storyboard 1 may also be inscribed with any other information such as biblical scripture, quotes, poems and the like. Moreover, the storyboard 1 may contain graphics selected by the family of the decedent, or the decedent before passing. In one embodiment, the storyboard 1 contains the name of a decedent, the date of birth and death, as well as religious graphics. The inscriptions on the storyboard 1 may be etchings made in either the upper or lower surface of the storyboard 1. Additionally, information may be contained within the material comprising the storyboard 1.

The storyboard 1 may be of many shapes such as rectangular, oblong, circular, square, or in the shape of religious symbols. In one preferred embodiment the storyboard 1 is rectangular in shape. Moreover, the size of the storyboard 1 may vary. In one embodiment, where the present invention is a headstone, the storyboard 1 is rectangular in shape and measures approximately 22⅜ inches in width, and approximately 18⅜ inches in length. Depending on the material used to make the storyboard 1, the thickness of the storyboard may vary, but is not of a thickness wherein light may not pass therethrough. In one embodiment, the storyboard 1 is composed of LEXAN® plastic and is approximately ¼ inch thick.

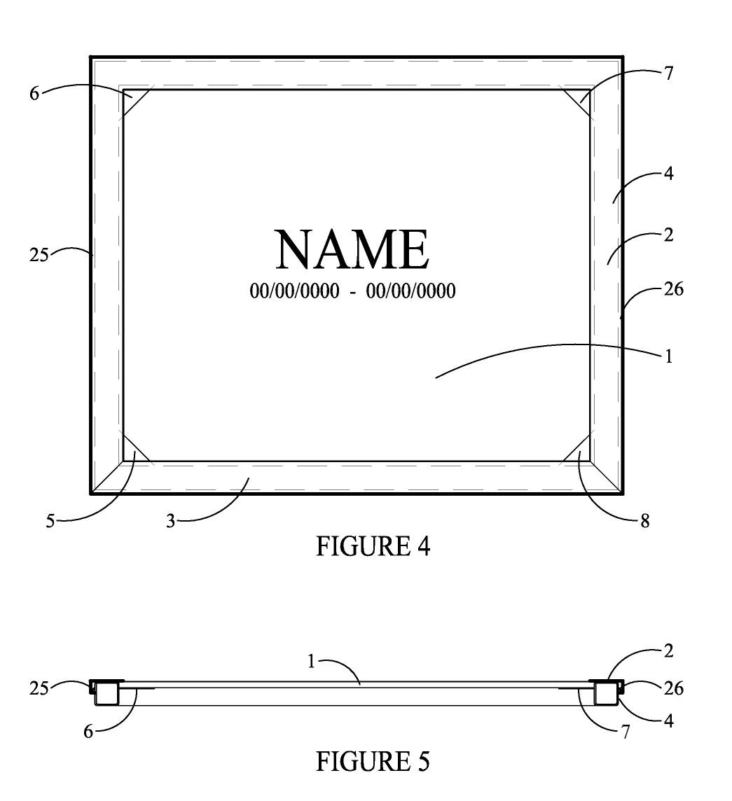

The storyboard 1 may have an upper frame 2 that covers the top ¾ of the storyboard 1, and an upper frame 3 that covers the bottom ¼ of the storyboard 1. The upper frame 2 & 3 is substantially the same shape as the storyboard 1, the upper frame 2 & 3 enclosing a portion of the upper surface of the storyboard 1. As will be apparent to one skilled in the art, a departure in shape between the upper frame 2 & 3 and storyboard 1 may be made. This is especially relevant where the upper frame 2 & 3 serves not only a functional purpose in anchoring the storyboard 1, but also an ornamental purpose. FIG. 4 illustrates the relationship between the storyboard 1 and upper frame 2 & 3.

The upper frame 2 & 3 may be composed of a variety of materials such as: plastics, epoxies, metals, woods, fiberglass, resins, polymers, polycarbonates, molding compounds, natural or synthetic fibers, and the like. In one embodiment where the storyboard 1 is LEXAN® plastic and measures approximately 22⅜ inches wide and approximately 18⅜ inches long, the upper frame 2 & 3 is made of stainless steel and measures ½ inches wide along the outer perimeter of the storyboard 1. The upper frame 2 & 3 encases the storyboard 1 on its upper surface, and then extends down through the thickness of the storyboard 1 attaching to the lower frame 4. The length of this portion of the upper frame 2 & 3 can be approximately ½ inch, as in one embodiment of the present invention, which extends below the thickness of the storyboard 1, when the thickness of the storyboard 1 is ¼ inch, as in one preferred embodiment of the present invention.

The upper frame 2 & 3 may be made as one piece, or where the upper frame 2 & 3 is steel, may be made by component pieces that are affixed to one another in a variety of ways. As in one embodiment, the upper frame 2 that covers the top ¾ of the storyboard 1 is rectangular in shape, and made of three pieces of steel that are connected by welding. In that embodiment, the upper frame 3 that covers the bottom ¼ of the storyboard 1 is of a bar shape and made of one piece of steel. The two ends of the bottom portion of the upper frame 3 and the ends of the upper portion of the upper frame 2 are such that they are contiguous when connected (i.e., a rectangular shaped frame is made when connected).

As in one embodiment, the upper portion of the upper frame 2 may slide into place, connecting to the lower frame 4 by a ridge 25 & 26 placed on the outside edge of the lower frame 4 to which the shape of the upper portion of the upper frame 2 connects with the lower portion of the ridge on two sides 25 & 26. This connection between the upper frame 2 and lower frame 4 is a ridge and sliding mechanism. FIG. 5 illustrates that the upper portion of the upper frame 2 extends slightly outward from the lower frame 4 and down past the width of the storyboard 1 and a portion of the lower frame 4, the upper frame 2 then extends inward to the lower frame 4 forming a “C” shape. The ridge 25 & 26 on the lower frame 4 catches the upper frame 2 and secures it into place, in one embodiment of the present invention.

In another embodiment, the storyboard 1 may be placed on the lower frame 4 and underneath the upper frame 2 & 3, where the upper frame 2 & 3 is affixed to the lower frame. As is well apparent in the art, the upper frame 2 & 3 may be affixed in a variety of ways including, glues, welding, fasteners, epoxy and the like. Moreover, a cover may be present on the upper surface of the storyboard 1 that may be a part of the upper frame 2 & 3, or may be connected thereto. Where a cover is present on the upper surface of the storyboard 1, the cover is transparent.

The storyboard 1 is secured in its position by the upper frame 2 & 3, described above, the lower frame 4, a metal screw 19, and four brackets 5, 6, 7, and 8. The lower frame 4 can be made of a variety of materials including plastics, metals, resins, woods, fiberglass, polymers, and natural or synthetic fibers. In one preferred embodiment of the present invention the lower frame 4 is made of steel tubing. This embodiment, the steel tubing used to make the lower frame 4 is approximately 1 inch square 22. The shape of the lower frame 4 is similar to the shape chosen for the storyboard 1 and the upper frame 2 & 3, in one embodiment. As will be apparent to one skilled in the art, a departure from shape in the lower frame 4 from the shape of the storyboard 1 is obvious, so long as the lower frame 4 is can support the storyboard 1. The lower frame 4 may be made as one piece, or may be made in multiple pieces that are affixed to each other. As in one embodiment, the approximately 1 inch square steel tubing of the lower frame 4, is made in four pieces, that are connected by an approximately ⅛ inch wide continuous weld to form a rectangular shape similar to the storyboard 1 and upper frame 2 & 3. The upper frame 2 & 3 may be affixed to the lower frame 4 by a variety of means. In one embodiment of the present invention, the upper frame 2 & 3 is made of steel and is welded to the lower frame 4 made of 1 inch square steel tubing. As stated above, in another preferred embodiment, a portion of the upper frame 2 slides over the ridges 25 & 26 on the lower frame 4 and is held in place by those ridges 25 & 26.

In one embodiment of the present invention, four brackets 5, 6, 7, and 8 are affixed to the lower frame 4, providing support to the storyboard 1. Where the lower frame 4 is rectangular in shape, each one of four brackets 5, 6, 7, and 8 are placed at the corners of the lower frame 4. Each bracket 5, 6, 7, and 8 is triangular in shape, wherein two of the sides of the triangle are approximately 1½ inches in length. Brackets of various shapes and sizes may be employed, as will be apparent to one skilled in the art. In one embodiment, each bracket 5, 6, 7, and 8 is made of steel. As is apparent to one skilled in the art, the bracket may be made of a variety of materials including, glass, plastics, resins, epoxies, polymers, fiberglass, polycarbonates, molding compounds, and natural or synthetic fibers. The brackets 5, 6, 7, and 8 in one preferred embodiment of the present invention are welded to the lower frame 4 with an approximately ⅛ inch continuous weld. In this embodiment, the brackets 5, 6, 7, and 8 are placed at a sufficient depth on the lower frame 4 so that the storyboard 1 will sit on the brackets 5, 6, 7, and 8, and the upper surface of the storyboard 1 will be in close proximity of the upper frame 2 & 3. The relationship between the storyboard 1, upper frame 2 & 3, lower frame 4, and brackets 5, 6, 7, and 8, is illustrated in FIG. 5.

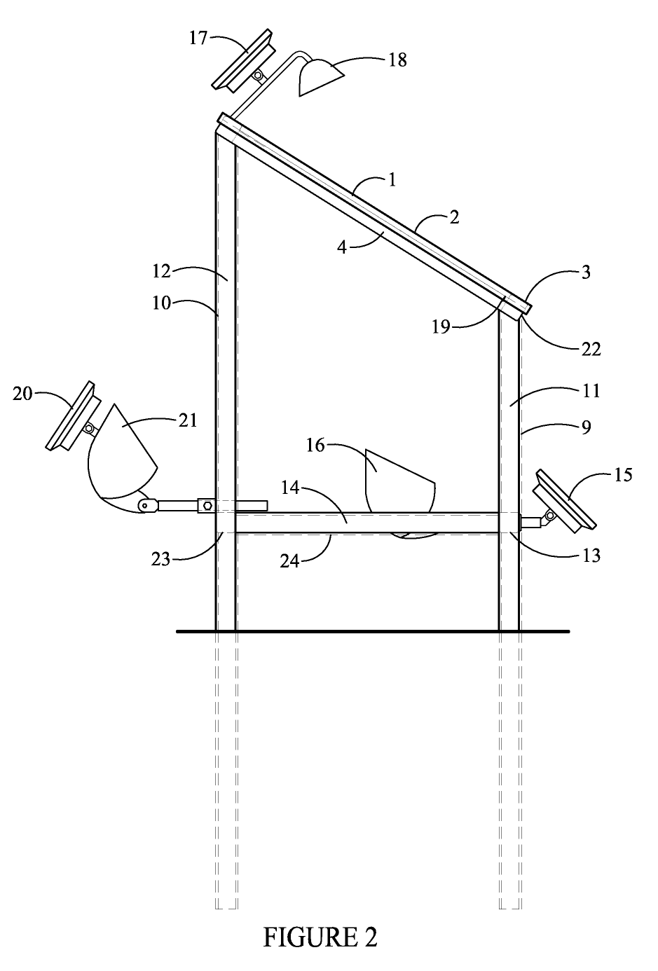

As in one embodiment of the present invention, the storyboard 1 and upper frame 2 & 3 may be secured to the lower frame 4 by a screw 19 located on the lower portion of the storyboard 1 and upper frame 2 & 3. While FIG. 2 illustrates one screw 19 in the lower right quadrant of the storyboard 1, another screw in the lower left quadrant may be used, as in the preferred embodiment. As will be apparent to one skilled in the art the type, number, and placement of fasteners used to secure the upper frame 2 & 3 and storyboard 1 to the lower frame 4 may vary. Fasteners include, but are not limited to, rivets, nails, screws, staples, and the like.

The lower frame 4 is connected to elongated members 9, 10, 11, & 12 that connect the present invention to a base. A base may be any permanent or semi-permanent surface including the earth, concrete, asphalt, pavement, sand, marble, granite, plastics, wood, metals, stones, natural or synthetic fibers, polycarbonates, molding compounds, resins, polymers and fiberglass. In one embodiment, where the lower frame 4 is rectangular in shape, four elongated members 9, 10, 11, & 12 extend from the four corners of the lower frame 4. As will be apparent to one skilled in the art, the number of elongated members may vary depending on the shape of the lower frame and storyboard, and on the aesthetic appearance desired, so long as the elongated member or members are sufficient to support the storyboard and its associated frames on a base. Moreover, while in the preferred embodiment of the invention the elongated members 9, 10, 11, & 12 are of sufficient length that they may be anchored within the earth, it will be apparent to one skilled in the art that the elongated member or members may not serve an anchoring purpose.

The elongated members 9, 10, 11, & 12 may be made of a variety of materials including metals, plastics, resins, epoxies, polymers, woods, polycarbonates, molding compounds, fiberglass, and natural or synthetic fibers. As in one preferred embodiment of the present invention, the elongated members 9, 10, 11, & 12 are made of steel tubing. In this embodiment, the steel tubing is approximately 1 inch by 1 inch by ⅛ inch steel tubing. The length of the elongated members 9, 10, 11, & 12 may vary depending on the desired height of the eternal light monument and desired orientation. In one preferred embodiment, two of the elongated members 9 & 11 are of a lower height than the other two elongated members 10 & 12. This difference in height between elongated members 9, 10, 11, & 12 places the lower frame 4 and associated upper frame 2 & 3 and storyboard 1 at an angle to the base. As in one preferred embodiment, the two front facing elongated members 9 & 11 are approximately 15¾ inches in height, and the rear facing elongated members 10 & 12 are approximately 26 3/16 inches in height. In this embodiment, when the lower frame 4 is attached to the elongated members 9, 10, 11, & 12 and the storyboard 1 secured thereto with the upper frame 2 & 3, the storyboard is angled approximately 32° from the base, and approximately 58° from the front elongated members 9 & 11. This orientation allows a viewer to see the information displayed by the storyboard 1 with ease. Other orientations and means of securing the storyboard 1 to a base will be apparent to one skilled in the art and do not depart from the scope of the present invention.

Where the present invention is to be anchored into the earth, as in one preferred embodiment, the length of the elongated members 9, 10, 11, & 12 are such that the members extend approximately 14 inches below the earth. This depth sufficiently anchors the present invention to the earth. Other depths may be utilized, as will be apparent to one skilled in the art.

Further structural support is provided by a front bar 13, back bar 23, right bar 14, and left bar 24. Any of the bars 13, 23, 14, or 24 may be made of a variety of materials including metals, plastics, resins, epoxies, polymers, woods, fiberglass, and natural or synthetic fibers. In a preferred embodiment of the present invention, each bar 13, 23, 14, & 24 is constructed of steel tubing, of similar make and size as the elongated members 9, 10, 11, & 12. The front bar 13 may be affixed to the elongated members 9 & 11 in a variety of means, including welding as in one embodiment of the present invention. As in one preferred embodiment, the front bar 13 is connected between elongated members 9 & 11 by welding. The front bar 13 may be located approximately 6 inches up from the base to which the present invention is attached. Likewise, the back bar 23 is affixed to elongated members 10 & 12. The back bar 23 in one embodiment is connected by welding to elongated members 10 & 12, as in one embodiment. In one embodiment, the back bar 23 is located six inches from the base to which the present invention is attached, and is parallel with the front bar 13. The right bar 14 is located between elongated members 11 & 12. In one embodiment, the right bar 14 connects elongated members 11 & 12, and is at the same height as the other bars 13, 23, & 24. The left bar 24 connects elongated members 9 & 10, and is of the same height of bars 13, 23, & 14, in one embodiment of the present invention. Where the left bar 24 is made of metal, connection to elongated members 9 & 10 may be accomplished through welding. Thus, in one preferred embodiment of the invention, all bars 13, 23, 14, & 24 are located approximately 6 inches from the base to which the eternal light monument is attached, and are attached to the elongated members 9, 10, 11, & 12 by welding. As is apparent to one skilled in the art, number and position of support bars 13, 14, 23 & 24 may vary depending on the number of elongated members used. In some embodiments of the present invention, no support bars may be present.

As exemplified in FIGS. 2 & 3 illumination of the translucent storyboard 1 of the present invention may be accomplished with lighting 16, 17, & 21 powered by solar panels 15, 18, & 20. In one preferred embodiment, a solar-powered lamp 15 & 16 is affixed to a front bar 13 that connects two of the elongated members 9 & 11. A solar panel 15 and associated light 16 are connected to the front bar 13. The solar panel 15 is oriented such that it is not shielded by the storyboard 1 above. The associated light 16 is placed beneath the storyboard 1. Thus, in one embodiment, when the light 16 is activated, light passes through the storyboard 1, giving a “glowing” effect as the light radiates up and through the storyboard 1. The associated light 16 may emit light in a variety of hues, as in one embodiment. Moreover the associated light 16 may be programmed such that it is only activated when sunlight is not available, or at any other desired time. Alternative orientations of the solar panel and positions of the lamp may be practiced without departing from the scope of the present invention.

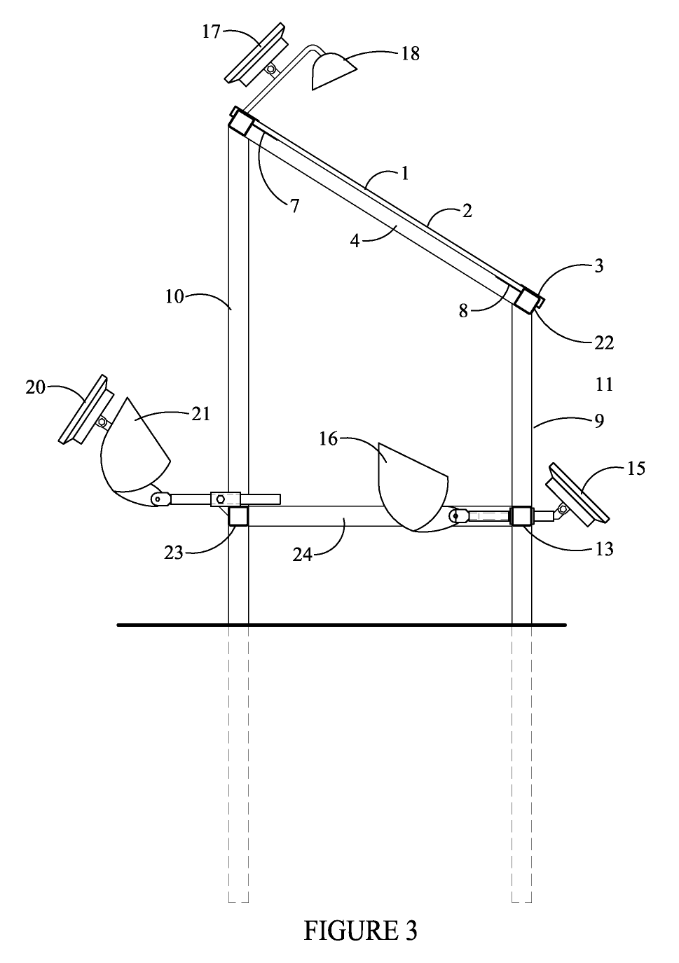

Illumination of the storyboard 1 of the present invention may be accomplished at a variety of positions. As in one embodiment, a solar panel 17 and associated light 18 may be located above the storyboard 1. In this embodiment, the solar panel 17 and associated light 18 are attached to the lower frame 4 and upper frame 2 & 3. When activated, the associated light 18 illuminates the storyboard 1 from below, accomplishing a “glowing” effect to the storyboard 1 as light radiates through the storyboard 1. As stated above, the associated light 18 may be activated at a variety of chosen times. A tertiary position for illumination is provided by a solar panel 20 and associated light 21 as seen in FIG. 3. In this embodiment, the solar panel 20 and associated light 21 is attached to the back bar 23. This tertiary position allows for additional illumination of the storyboard 1 from below, as is preferred in one embodiment of the invention. As stated in reference to associated light 16, any light used for illumination of the storyboard 1 may emit light at prescribed times, in response to visible light intensity, and in a variety of hues, as will be apparent to one skilled in the art. Placement and orientation of illuminating elements, as well as the quantity of illuminating elements in the present invention may vary, as will be apparent to one skilled in the art.

I claim:

1. A monument comprising:
a storyboard that is substantially translucent;
a frame that is of similar shape to the storyboard, said frame capable to attach to the lower surface of the storyboard or capable of receiving the storyboard within said frame wherein said frame has an upper and lower portion in which the storyboard may reside between said upper and lower portion of the frame;
at least one elongated member affixed to the frame and extending to a base, wherein an illuminating means may be placed within the space between the frame and the base; and
means for illuminating the storyboard.

2. The monument of claim 1, wherein said means for illuminating the storyboard is a solar-powered light.

3. The monument of claim 1, wherein said means for illuminating the storyboard is positioned above or below the storyboard.

4. The monument of claim 1, wherein the storyboard contains information regarding the life of a decedent, said information being inscribed within or on the storyboard and the storyboard capable of displaying graphics.

5. The monument of claim 1, wherein the at least one elongated member that attaches to and extends from the frame is positioned such that the frame and the storyboard are displayed above the base and at an angle not less than parallel to the base and not greater than perpendicular to the base.

6. The monument of claim 1, wherein the base is earth, and said at least one elongated member attaches to the frame extends from the frame into the earth to a sufficient depth so as to anchor the monument into the earth.

7. The monument of claim 1, wherein the at least one elongated member comprises four elongated members that are affixed to the frame and extend from the frame into the earth to a sufficient depth so as to anchor the monument into the earth.

8. The monument of claim 1, wherein the storyboard is constructed of a polycarbonate resin sheet material and molding compound, sold under the trademark LEXAN.

9. The monument of claim 1, wherein the monument is a memorial, headstone, gravestone, or mausoleum plaque.

10. The monument of claim 1, wherein the base is the earth or other permanent or semi-permanent surface.

11. The monument of claim 1, wherein the upper portion of the frame couples to the lower portion of the frame by a ridge and sliding mechanism.

12. The monument of claim 1, wherein the frame and storyboard are secured to each other through the use of at least one fastener.

13. A monument comprising:
a storyboard that is substantially translucent;
a frame that is substantially the same shape as the storyboard, said frame capable to affix to the lower surface of the storyboard or capable of receiving the storyboard within said frame wherein said frame has an upper and lower portion in which the storyboard may reside;
at least one elongated member that affixes to the frame and extends from the frame so that the monument may be secured to the earth or placed on a permanent or semi-permanent surface; and
at least one illuminating device attached below or above the storyboard.

14. The monument of claim 13, wherein said at least one illuminating device is a solar-powered light.

15. The monument of claim 13 wherein the storyboard and the frame are in a shape containing four sides, and four elongated members are affixed to the frame and extend therefrom and wherein two of said elongated members are of the same height, and the other two of said elongated members are of the same height, so that the storyboard is at an angle not less than parallel to the earth or other permanent surface and not greater than perpendicular to the earth or other permanent surface when the elongated members are so affixed.

16. The monument of claim 13, wherein the storyboard and the frame are an oval, circle, cross, rectangle, or square shape.

17. The monument of claim 13, wherein the storyboard is constructed of LEXAN® plastic.

18. The monument of claim 13, wherein the monument is a memorial, headstone, gravestone, or mausoleum plaque.

19. The monument of claim 13, wherein the upper portion of the frame couples to the lower portion of the frame by a ridge and sliding mechanism.

20. The monument of claim 13, wherein the frame and storyboard are secured to each other through the use of at least one fastener.
